(19) United States
(12) Patent Application Publication
(10) Pub. No.: US 2026/0159626 A1
(43) Pub. Date: Jun. 11, 2026

(54) GEL POLYMERIZED WATER-SOLUBLE POLYMERS

(71) Applicant: SNF GROUP, Andrezieux Boutheon (FR)

(72) Inventors: Aurélien DUCHADEAU, ANDREZIEUX BOUTHEON (FR); Bruno TAVERNIER, ANDREZIEUX BOUTHEON (FR); Cédrick FAVERO, ANDREZIEUX BOUTHEON (FR); Nicolas BOISSE, TAIXING CITY (CN); Jing LING, TAIXING CITY (CN); Qinglin XU, TAIXING CITY (CN)

(73) Assignee: SNF GROUP, Andrezieux Boutheon (FR)

(21) Appl. No.: 18/703,937

(22) PCT Filed: Oct. 24, 2022
(86) PCT No.: PCT/EP2022/079662

§ 371 Date: Apr. 23, 2024

(30) Foreign Application Priority Data
Oct. 27, 2021 (FR) 2111411

(51) Int. Cl. C08F 293/00; C08J 3/12

(52) U.S. Cl. CPC C08F 293/005; C08J 3/12; C08J 2353/00

(57) ABSTRACT

This invention relates to a water-soluble P1 polymer of weight-average molecular weight less than 2 million Daltons in powder form prepared by a gel polymerization process comprising the following sequential steps of:
a) Forming an S1 solution by adding, and mixing, in a polymerization reactor:
   between 20 and 60% by weight of hydrophilic monomers,
   between 30 and 79% by weight of a P2 polymer containing at least 1% by weight of hydrophobic monomers,
b) Adding a pH regulator to the S1 solution,
c) Degassing the S1 solution,
d) Adding at least one polymerization initiator to the S1 solution, the S1 solution being at a temperature between −5° C. and 30° C.,
e) Forming a P1 polymer gel by polymerizing the S1 solution from step d) and allowing the P1 polymer gel to age at a final polymerization temperature between 80° C. and 150° C. for at least 60 minutes without heating,
f) Pouring the resulting P1 polymer gel into a granulator,
g) Drying the P1 polymer gel,
h) Grinding and sieving the P1 polymer into a powder.

### FIELD OF THE INVENTION

This invention relates to water-soluble synthetic polymers with a weight-average molecular weight of between 500,000 Daltons and 2 million Daltons in powder form used as coagulants, flocculants, or thickeners in multiple applications. More specifically, the subject-matter of the invention is water-soluble synthetic polymers and a gel polymerization process to obtain water-soluble synthetic polymers of low molecular weight.

### PRIOR ART

High molecular weight water-soluble synthetic polymers are commonly used in many applications due to their flocculating or thickening properties. Indeed, these polymers are used in the oil and gas industry, hydraulic fracturing, papermaking processes, sludge dewatering, water treatment, construction, mining, cosmetics, agriculture, textiles, and detergents.

By way of example, the flocculant nature of these water-soluble synthetic polymers of high molecular weight is used in the field of water treatment/sludge dewatering. Indeed, after an optional coagulation step where colloidal particles (assimilated to spheres smaller than 1 micrometer) of a given water are destabilized, flocculation represents the step where particles are gathered into high molecular weight aggregates to generate a rapid sedimentation. Water-soluble polymers used for water treatment are mainly in the form of powder or water-oil inverse emulsion. Depending on the water to be treated, the physical properties of the flocculant are modulated. Thus, the ionic character (nonionic, anionic, cationic, amphoteric, zwitterionic), the molecular weight or the structure (linear or structured, or even crosslinked) of the water-soluble polymer may be adapted.

The thickening character of these polymers may be exploited in the field of enhanced oil recovery (EOR). The efficiency of water injection sweeping is generally improved by the addition of water-soluble synthetic high molecular weight (co)polymers. The expected and proven benefits of using these (co)polymers, through the “viscosification” of the injected water, are improved sweeping and reduced viscosity contrast between fluids to control their mobility ratio in the field, to recover oil quickly and efficiently. These (co)polymers increase the viscosity of water.

The weight-average molecular weight of these water-soluble polymers is generally between 500,000 Daltons and 30 million Daltons. To obtain these polymers in powder form, gel polymerization may be used. The main steps of this polymerization method are the polymerization of the hydrophilic monomers in the aqueous phase, the discharge of the polymer gel thus obtained from the reaction vessel, the granulation of the polymer gel in a granulator, the drying of the polymer gel to obtain a water-soluble polymer in powder form and finally grinding and sieving the powder.

For the discharge of the polymerization reactor, the granulation and the drying step, the gel must be sufficiently viscous to “self-support”. In order to measure this property, a cylinder of gel 10 cm in diameter and 10 cm thick is cut from the polymer mass, which is placed on a flat surface and which is left to stand for 1 hour at 25° C. We then define a form factor F on the volume obtained as being the ratio of the horizontal section to the vertical section: F=L/H (see FIG. 1).

If the ratio is less than 3, the gel will “self-support”. In the opposite case, it will not self-support.

In order to be self-supporting, the gel must be viscoelastic. And when the weight-average molecular weight of water-soluble polymers is between 500,000 Daltons and 2 million Daltons, the gel might not be sufficiently viscoelastic to be processable (discharged, granulated, and dried).

An increase in the concentration of monomers in the polymerization reactor may be one way to achieve the required consistency of the gel but, accordingly, in the case of an exothermic polymerization reaction, the final polymerization temperature and the final pressure at the interior of the reaction vessel will increase, requiring adaptation of the reaction vessel.

### DISCLOSURE OF THE INVENTION

Surprisingly, the Applicant found that a water-soluble polymer with a weight-average molecular weight of less than 2 million Daltons in powder form may be prepared using a gel polymerization process with a polymer gel consistency sufficient for the reactor discharge, granulation, grinding, and drying steps, by carrying out the polymerization in a solution containing, among others, among others, a water-soluble polymer containing at least 1% by weight of hydrophobic monomers.

More specifically, the invention relates to a water-soluble P1 polymer in powder form with a weight-average molecular weight of less than 2 million Daltons. This water-soluble P1 polymer is prepared by a gel polymerization process comprising the following sequential steps:
a) Forming an S1 solution by adding, and mixing, in a polymerization reactor:
   between 20 and 60% by weight of hydrophilic monomers,
   between 30 and 79% by weight of water,
   between 1 and 10% by weight of a P2 polymer containing at least 1% by weight of hydrophobic monomers,
b) Adding a pH regulator to the S1 solution,
c) Degassing the S1 solution,
d) Adding at least one polymerization initiator to the S1 solution. The S1 solution should be at a temperature between −5° C. and 30° C.,
e) Forming a P1 polymer gel by polymerizing the S1 solution (P2 polymer+hydrophilic monomers+pH regulator+polymerization initiators) from step d) and allowing the P1 polymer gel to age at a final polymerization temperature between 80° C. and 150° C. for at least 60 minutes without heating,
f) Pouring the resulting P1 polymer gel into a granulator,
g) Drying the P1 polymer gel,
h) Grinding and sieving the P1 polymer into a powder.

In step e), polymerizing the S1 solution means polymerizing polymerizable compounds of the S1 solution, for instance the hydrophilic monomers.

The invention also relates to a process for preparing the water-soluble P1 polymer according to steps a) to h). Advantageously, the gel polymerization process does not comprise an intermediate step between the different steps a) to h).

The value ranges include the lower and upper bounds. Thus, the value ranges “between 0.1 and 1.0” and “from 0.1 to 1” include the values 0.1 and 1.0.

The term “polymer” refers to both homopolymers and copolymers of at least two different monomers.

As used herein, the term “water-soluble polymer” refers to a polymer that yields an aqueous solution with no insoluble particles when dissolved with agitation for 4 hours at 25° C. and a concentration of 20 g. L-1 in deionized water.

As used herein, the term “hydrophilic monomer” refers to a monomer that exhibits a partition coefficient octanol/water, Kow, of less than 1, wherein the Kow partition coefficient is determined at 25° C. in an octanol/water mixture having a 1/1 volume ratio, at a pH of between 6 and 8.

As used herein, the term “hydrophobic monomer” refers to a monomer that exhibits a partition coefficient octanol/water, Kow, of more than 1, wherein the Kow partition coefficient is determined at 25° C. in an octanol/water mixture having a 1/1 volume ratio, at a pH of between 6 and 8.

The partition coefficient octanol/water, Kow, represents the ratio of concentrations (g/L) of a monomer between the octanol phase and the water phases. It is defined as follows:

$$Kow = \frac{{[ monomer ]}_{octanol}}{{[ monomer ]}_{water}}$$

According to this invention, solution S1, refers to a liquid aqueous composition of at least one compound (polymer, monomers . . . ). The solution may possibly include insolubles. This may be the case in particular when the S1 solution comprises water and a P2 polymer containing one or more hydrophobic monomer(s).

The P1 polymer may be non-ionic, anionic, cationic, or amphoteric. An amphoteric polymer is a polymer comprising cationic charges and anionic charges, preferably as many anionic charges as cationic charges.

Thus, for step a) of the gel polymerization process of the P1 polymer, the hydrophilic monomers added to the polymerization reactor may be nonionic and/or anionic and/or cationic and/or zwitterionic.

The nonionic monomers are preferably selected from the group containing acrylamide, methacrylamide, N-alkyl acrylamides, N-alkylmethacrylamides, N,N-dialkyl acrylamides, N,N-dialkylmethacrylamides, N-vinyl pyridine, N-vinylpyrrolidone, hydroxyalkyl acrylates, hydroxyalkyl methacrylates, and mixtures thereof. Among these nonionic monomers, the alkyl groups are advantageously C₁-C₅, more advantageously C₁-C₃. The C₁-C₈alkyl groups are preferably linear.

Anionic monomers are preferably selected from the group comprising monomers having a carboxylic acid function and their salts, including acrylic acid, methacrylic acid, itaconic acid and maleic acid; monomers with a sulfonic acid function and their salts, including acrylamido tertiary butyl sulfonic acid (ATBS), allyl sulfonic acid and methallyl sulfonic acid, and their salts; and monomers having a phosphonic acid function and their salts.

Generally speaking, the anionic monomer salts of the P1 polymer are salts of an alkali metal (preferably sodium), an alkaline earth metal (preferably calcium or magnesium) or an ammonium (preferably a quaternary ammonium).

Cationic monomers are preferably selected from the group consisting of quaternized or salified dimethyl aminoethyl acrylate (ADAME), quaternized or salified dimethyl aminoethyl methacrylate (MADAME), diallyl dimethyl ammonium chloride (DADMAC), acrylamido propyl trimethyl ammonium chloride (APTAC), and methacryl amido propyl trimethyl ammonium chloride (MAPTAC).

Advantageously, the cationic monomers of the P1 polymer have a halide as a counterion, preferably a chloride ion.

Zwitterionic monomers are preferably selected from the group consisting of sulfobetaine monomers such as sulfopropyl dimethylammonium ethyl methacrylate, sulfopropyl dimethyl ammonium propyl methacrylamide, or sulfopropyl 2-vinyl pyridinium; phosphobetaine monomers, such as phosphato ethyl trimethyl ammonium ethyl methacrylate; and carboxybetaine monomers.

The P1 Polymer may be linear, structured, or cross-linked. The cross-linking agents allowing the structuring can in particular be chosen from sodium allyl sulfonate, sodium methallyl sulfonate, sodium methallyl disulfonate, methylenebisacrylamide, triallylamine, triallyl ammonium chloride, tetraallyl ammonium chloride.

According to this invention, the weight-average molecular weight of the synthetic water-soluble the P1 polymer is determined by measuring the intrinsic viscosity. Intrinsic viscosity may be measured by methods known to the person skilled in the art and may in particular be calculated from the reduced viscosity values for different concentrations by a graphical method consisting of plotting the reduced viscosity values (on the y-axis) as a function of the concentrations (on the x-axis) and extrapolating the curve to zero concentration. The intrinsic viscosity value is read on the y-axis or using the least squares method. Then, the weight-average molecular weight may be determined by the famous Mark-Houwink equation:

[η]=K M^{α}

[η] represents the intrinsic viscosity of the polymer determined by the solution viscosity measurement method,
K represents an empirical constant,
M represents the molecular weight of the polymer,
α represents the Mark-Houwink coefficient,
α and K depend upon the particular polymer-solvent system. Tables known to the person skilled in the art give the values of a and K according to the polymer-solvent system.

The invention's water-soluble the P1 polymer has a weight-average molecular weight of less than 2 million Daltons, preferably between 500,000 Daltons and less than 2 million Daltons.

For process step a) P2 polymer contains at least 1% by weight of hydrophobic monomers. The P2 polymer may be non-ionic, anionic, cationic, or amphoteric. In addition to hydrophobic monomers, it may consist of nonionic and/or anionic and/or cationic and/or zwitterionic monomers, preferably selected from the same lists previously described for P1.

The hydrophobic monomers of the P2 polymer have a Kow partition coefficient of more than 1. They are preferably selected from the following list: (meth)acrylic acid esters with an alkyl, arylalkyl and/or ethoxylated and/or propoxylated chain; (meth)acrylamide derivatives with an alkyl, arylalkyl or dialkyl and/or ethoxylated and/or propoxylated chain; cationic allyl derivatives having an alkyl, arylalkyl or dialkyl chain and/or an ethoxylated and/or propoxylated chain; hydrophobic anionic or cationic (meth)acryloyl derivatives; and anionic or cationic monomeric (meth)acrylamide derivatives bearing a hydrophobic chain. The hydrophobic monomers of the P2 polymer may comprise halogen atoms, for instance chloride.

Among the hydrophobic monomers of the P2 polymer:
the alkyl groups are preferably C₃-C₂₀, more preferably C₃-C₈. C₆-C₂₀ alkyls are preferably linear alkyls while the C₃-C₅ alkyl are preferably branched,
the arylalkyl groups are preferably C₇-C₂₅, more preferably C₇-C₁₅
the ethoxylated chains preferably comprise 6 to 100 —CH₂—CH₂—O— groups, more preferably 10 to 40,
the propoxylated chains preferably comprise 0 to 50 —CH₂—CH₂—CH₂—O— groups, more preferably 0 to 20.

Even more specifically, the hydrophobic monomers of the P2 polymer can be selected from the following lists:
n-hexyl (meth)acrylate, n-octyl (meth)acrylate, octyl (meth)acrylamide, N-tert-butyl (meth)acrylamide, lauryl (meth)acrylate, myristyl (meth)acrylate, myristyl (meth)acrylamide, pentadecyl (meth)acrylate, pentadecyl (meth)acrylamide, cetyl (meth)acrylate, cetyl (meth)acrylamide, oleyl (meth)acrylate, oleyl (meth)acrylamide, erucyl (meth)acrylate, erucyl (meth)acrylamide, and combinations thereof;
hydrophobic monomers of the general formula

CH₂—CR¹—COO—(EO)ₙ—(PO)ₘ—R²

wherein R¹ is hydrogen or methyl, n is an integer of at least two, preferably from 6 to 100 or from 10 to 40, m is an integer from zero to 50, preferably from zero to 20, EO is an ethylene oxide group (—CH₂—CH₂—O—), PO is a propylene oxide group (—CH₂—CH(CH₃)—O—) and R² is a C₈-C₃₀ alkyl group or a C₈-C₃₀ arylalkyl group, and n+m is preferably from 6 to 100 or from 10 to 40. Preferably these should be linear alkyls.

More preferably, the hydrophobic monomers of P2 are selected from the following list: halogenoalkylated (preferably bromo alkylated) derivatives of methacryl amido dimethyl aminopropyl with a C₈-C₁₆ alkyl chain, ethoxylated behenyl methacrylate, N-tert-butyl acrylamide. These are preferably linear alkyls.

Even more preferably, the P2 polymer is a terpolymer of diethyl acrylamide, N-tert-butyl acrylamide and sodium 2-acrylamido-2-methylpropanesulfonate.

The P2 polymer contains between 1 and 100% by weight of hydrophobic monomers, preferably between 2 and 100% by weight, even more preferably between 5 and 100% by weight, even more preferably between 10 and 100% by weight, and even more preferably between 20 and 100% by weight of hydrophobic monomers.

In a preferred embodiment, the P2 polymer is functionalized at the end of the polymer chain with a hydroxyl, cyano, amine, phosphate, phosphonate, sulfate, sulfonate, xanthate, trithiocarbonate, dithiocarbamate, or dithioester fragment. The P2 polymer can also be free of any of these end-chain functionalization.

According to another preferred embodiment, the P2 polymer contains at least one carbon-carbon double bond, for instance a terminal carbon-carbon double bond. The P2 polymer can also be free of any carbon-carbon double bond.

In step a) (formation of the S1 solution) of the process to obtain the P1 polymer, the S1 solution comprises, by weight:
between 20 and 60% of hydrophilic monomers preferably between 20 and 50%, even more preferably between 30 and 50%,
between 30 and 79% of water, or sufficient quantity of water for 100%,
between 1 and 10% of polymer P2, preferably between 1 and 8%, even more preferably between 1 and 6%.

For step b) of the process to obtain the P1 polymer, the pH regulator is advantageously composed of one or more of the following elements: hydrochloric acid, sulfuric acid, phosphoric acid, nitric acid, citric acid, formic acid, acetic acid, adipic acid, propionic acid, oxalic acid, benzoic acid, sodium hydroxide, potassium hydroxide, sodium carbonate, sodium bicarbonate The person skilled in the art will know how to define the pH to be reached at the end of step b) as well as the quantity and the choice of the pH regulators according to the chemistry of the polymer to be synthesized, in particular according to the nature of the monomers (cationic, anionic . . . ).

For step c), in order to remove the residual oxygen from the solution obtained at the end of step b), an inert gas is introduced in order to degas the S1 solution. Inert gas is usually passed through the solution. Suitable inert gases for this purpose are, for example, nitrogen, carbon dioxide or rare gases such as neon or helium. Argon may also be used.

During the addition of the polymerization initiator (step d)), the S1 solution is at a temperature of −5° C. to 30° C., preferably between 0 and 10° C.

The gel polymerization of the process of the invention is carried out by a radical route. It includes free radical polymerization by means of UV, azo, redox, or thermal initiators as well as controlled radical polymerization techniques (CRP) or more particularly RAFT (Reversible Addition Fragmentation Chain Transfer).

The usual polymerization regulators may be used. These may include sulfur compounds such as thioglycolic acid, mercapto alcohols, dodecyl mercaptan, amines such as ethanolamine, diethanolamine, morpholine and phosphites such as sodium hypophosphites. In the case of RAFT polymerization, specific polymerization regulators such as those comprising a transfer group including the —S—CS— function, may be used. Examples of such compounds are xanthates (—S—CS—O—), dithioesters (—S—CS-Carbon), trithiocarbonates (—S—CS—S—), or dithiocarbamates (—S—CS—Nitrogen). Among the compounds of the xanthate family, O-ethyl-S—(1-methoxy carbonyl ethyl) xanthate may be advantageously employed because of its compatibility with monomers of acrylic nature.

The polymerization initiators used in step d) of the process for obtaining P1 polymer may be any compounds that dissociate into radicals under the polymerization conditions, for example: organic peroxides, hydroperoxides, hydrogen peroxide, persulfates, azo compounds, and redox catalysts. The use of water-soluble initiators is preferred. In some cases, it is advantageous to use mixtures of various polymerization initiators, for example, mixtures of redox catalysts and azo compounds.

Suitable organic peroxides and hydroperoxides are, for example, sodium or potassium peroxodisulfate, acetylacetone peroxide, methylethylketone peroxide, tert-butyl hydroperoxide, cumene hydroperoxide, tert-amyl perpivalate, tert-butyl perpivalate, tert-butyl perneohexanoate, tert-butyl perbuto-butylate,-ethyl hexanoate, tert-butyl perisononanoate, tert-butyl permaleate, tert-butyl perbenzoate, or tert-butyl per-3,5,5-trimethylhexanoate and tert-amyl perneodecanoate.

Suitable persulfates may be selected from alkali metal persulfates such as sodium persulfate.

Suitable azo initiators are advantageously water-soluble and selected from the following list: 2,2′-azobis-(2-amidinopropane) dihydrochloride, 2,2′-azobis (N,N′-dimethylene) isobutyramidine dihydrochloride, 2-(azo (1-cyano-1-methylethyl))-2-methylpropane nitrile, 2,2′-azobis [2-(2′-dimidazolin-2-yl) propane]dihydrochloride, and 4,4′-azobis acid (4-cyanovaleric acid)

Said polymerization initiators are used in usual amounts, for example in amounts that may vary from 0.001 to 2%, preferably from 0.01 to 1% by weight, based on the monomers to be polymerized (hydrophilic monomers added in step a)).

As oxidizing component, the redox catalysts advantageously contain at least one of the above-mentioned compounds and, as a reducing component, for example ascorbic acid, glucose, sorbose, hydrogen sulfite, sulfite, thiosulfate, hyposulfite, pyrosulfite or alkali metal, metal salts, such as in the form of iron (II) ions or silver ions or sodium hydroxy methyl sulfoxylate. The reducing component of the redox catalyst used is preferably Mohr's salt (NH₄)₂Fe(SO₄)₂, 6 H₂O.

Based on the amount of monomers used in the polymerization, from 5×10⁶ to 1 mole % of the reducing component of the redox catalyst system and from 5×10⁻⁵ to 2 mole % of the oxidizing component of the redox catalyst may be used, as an example. Instead of the oxidizing component of the redox catalyst, one or more water-soluble azo initiators may also be used.

The polymerization is carried out in the absence of oxygen (degassing step c)), by introducing the initiators in the appropriate order, known to the person skilled in the art, into the solution to be polymerized. The initiators are introduced either in soluble form in an aqueous medium or as a solution in an organic solvent.

In step e) (advantageously also in step d)), all the constituents of the S1 solution (P2 polymer+hydrophilic monomers+pH regulator+polymerization initiators) are advantageously solubilized, more advantageously in water. Indeed, the different constituents can allow the solubilization of constituents that would not be soluble in the main solvent, for example, water. For example, hydrophilic monomers may allow the P2 polymer to be solubilized in water, even when it predominantly comprises hydrophobic monomers. In this case, the hydrophilic monomers act as co-solvent for the P2 polymer.

Thus, at the end of step d), the S1 solution is advantageously free of insolubles.

According to a preferred embodiment, the S1 solution is an aqueous solution.

Generally speaking, the P1 polymer is water-soluble while the P2 polymer is not necessarily water-soluble.

As soon as polymerization begins, the reaction mixture is heated or heats up (exothermic reaction) in step e) for the process to obtain the P1 polymer, depending on the starting conditions selected. Advantageously, due to the heat released from the polymerization, the temperature of the reaction mixture is 80 to 150° C., preferably 80° C. to 100° C.

The polymerization reactor used as early as in step a) of the process, may be jacketed so that the reaction mixture may be cooled or heated as required. Once the polymerization reaction is complete, the resulting polymer gel may be quickly cooled by cooling the reactor wall, for example.

At the end of the polymerization reaction in step f) (end of step e)), after allowing the P1 polymer gel to age for at least 60 minutes, the polymerization product is a gel that is viscous enough to be “self-supporting.”

As already mentioned, a self-supporting gel has a form factor F of less than 3. In order to measure this form property F, a cylinder of gel 10 cm in diameter and 10 cm thick is cut from the polymer mass, which is placed on a flat surface and which is left to stand for 1 hour at 25° C. Form factor F is the ratio of the horizontal to the vertical cross-section of the cylinder left at rest for 1 hour: F=L/H (see FIG. 1).

In order to facilitate the discharge of the gel from the reactor at the end of the reaction (step f)), the reactor is advantageously in the form of an inverted conical tube (cone downwards) in order to discharge the gel downwards by applying pressure, e.g., inert gas or air, on the surface of the gel or in the form of a tilter to discharge the gel mass by tilting the reactor.

Preferably, the reactor is in an inverted conical tubular form (cone down).

Step f) of the process of the invention consists of discharging the P1 polymer gel obtained in step e) into a granulator. Granulation consists of cutting the gel into small pieces. Advantageously, the average size of these gel pieces is less than 1 cm, more advantageously it is between 4 and 8 mm. The person skilled in the art will know how to choose the appropriate means for an optimal granulation. Granulation is also described in the prior art section.

Step g) of the process consists of drying the P1 polymer. The drying method and its conditions (time+temperature) are routine choices for the person skilled in the art. Industrially, drying is advantageously carried out using a fluidized bed or rotor dryer, advantageously aided by air heated to a temperature between 70° C. and 200° C., the air temperature being a function of the nature of the product as well as the drying time applied. After drying (end of step g)), the water-soluble P1 polymer is physically in powder form.

In step h) of the process, the P1 polymer powder is ground and sieved. The grinding step consists of breaking the large polymer particles into smaller particles. This may be done by shearing or by mechanical crushing of the particles between two hard surfaces. Various types of equipment known to the person skilled in the art may be used for this purpose. As examples, we may mention rotor mills, where the rotating part crushes the particles on a compression blade, or the roller mill, where the particles are crushed between two rotating rollers. The purpose of sieving is then to eliminate, based on the specifications, the medium-sized particles that are too small or too large.

The following examples illustrate the invention without limiting its scope.

### DESCRIPTION OF THE FIGURES

FIG. 1 illustrates the determination of the F=L/H factor (upper side of the polymer gel cylinder).

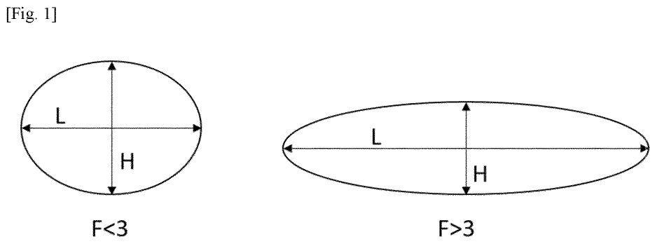

### EXAMPLES OF EMBODIMENTS OF THE INVENTION

### Example 1: Gel Synthesis of a P1a Acrylamide/Sodium Acrylate Copolymer, by Adding 3% by Weight of the P2a Polymer Containing 3% by Weight of Hydrophobic Monomer to the Polymerization Charge

In a first step, the P2a polymer of composition by weight: 3% N-tert-butyl acrylamide, 39% diethyl acrylamide, 8% sodium 2-acrylamido-2-methyl propane sulfonate, 50% acrylamide is synthesized in aqueous solution (8.3% by weight) by radical polymerization.

In a second step, the P1a polymer is synthesized by a free radical gel polymerization process from an aqueous solution comprising 3% by weight of the P2a polymer according to the following protocol: 30 g of the P2a polymer (361 g of the aqueous solution at 8.3% by weight of the P2a), 79 g of acrylic acid, 403 g of acrylamide at 50% by weight in water and 70 g of sodium chloride are introduced into a 1.5 L beaker. Neutralization of the aqueous solution is performed using 87 g of sodium hydroxide at 50% by weight in water to reach a pH in the Sla solution of between 6.5-7.5. The dry matter of the aqueous Sla solution is 40.6% by weight. This aqueous Sla solution is placed in a 2 L beaker and cooled to 0° C. 1.5 g of azobisisobutyronitrile are introduced into the aqueous S1a solution which is then homogenized using a hand blender at a speed of 500 rpm for 20 seconds before being degassed under nitrogen bubbling for 20 minutes.

To the aqueous S1a solution, expressed with respect to the total amount of monomers involved, 1.2×10⁻¹ mole % of sodium hypophosphite, 2.4×10⁻⁴ mole % of diethylene triamine penta acetic acid (DTPA) are then added, then the reaction is initiated by successive additions of 1.3×10⁻³ mole % of sodium persulfate and then 5.2×10⁻⁴ mole % of Mohr salt. The reaction time is 60 minutes, for a final temperature of 94° C. The resulting P1a polymer is in the form of a gel with an F factor=2.1. Therefore, it is possible to granulate and then dry it in a stream of air at 70° C. for 60 minutes. The dry grains of the P1a polymer are then ground to obtain a particle size of less than 1.7 mm. The P1a polymer obtained is 100% water-soluble and has a molar mass of 966,000 Da.

### Example 2 (Counter Example): Gel Synthesis of an Acrylamide/Sodium Acrylate P1b Copolymer Under the Same Conditions as Described in Example 1, Except for the Addition of the P2a Polymer

In this example, the P1b polymer is synthesized as described in Example 1, replacing the 361 g of the 8.3% solution of the P2a polymer with 30 g of urea and 331 g of deionized water. The amount of dry matter in the aqueous solution to be polymerized is therefore identical to that of Example 1, namely 40.6% by weight.

The polymerization conditions and catalyst system are identical to those described in Example 1.

The reaction time is 80 minutes, for a final temperature of 90° C. The resulting P1b polymer gel has an F-factor=5.2 and is not self supporting. After oven drying, a 100% water-soluble P1b polymer with a molar mass of 867,000 Da is obtained.

We clearly observe differences here in gel texture between two polymers (P1a and P1b) which nevertheless have a similar molar mass, and which are derived from two polymeric charges with the same amount of dry matter.

### Example 3: Gel Synthesis of a P1c Acrylamide/Sodium Acrylate Copolymer, by Adding 2% by Weight of the P2b Polymer Containing 5% by Weight of Hydrophobic Monomer to the Polymerization Charge and Carrying a Carbon-Carbon Double Bond

In a first step, the P2b polymer of composition by weight: 5% N-tert-butyl acrylamide, 78% diethyl acrylamide, 17% sodium 2-acrylamido-2-methyl propane sulfonate is synthesized in aqueous solution (5.5% by weight) by free radical polymerization in the presence of 2-aminoethanethiol as a limiting agent. The functionalization of the polymer thus formed with the double bond is carried out by adding acryloyl chloride at basic pH.

In a second step, the P1c polymer is synthesized by a bulk polymerization process and by gel radical polymerization from an S1c aqueous solution comprising 2% by weight of the P2b polymer according to the following protocol: 20 g of the P2c polymer (361 g of the aqueous solution at 5.5% by weight of the P2c), 79 g of acrylic acid, 403 g of acrylamide at 50% by weight in water and 70 g of sodium chloride are introduced into a 1.5 L beaker. Neutralization of the aqueous solution is performed using 87 g of sodium hydroxide at 50% by weight in water to reach a pH in the S1c solution of between 6.5-7.5. The dry matter of the aqueous S1c solution is 39.6% by weight. This aqueous S1c solution is cooled to 0° C. before being placed in a Dewar. 1.5 g of azobisisobutyronitrile are introduced into the S1c solution which is then homogenized using a hand blender at a speed of 500 rpm for 20 seconds before being degassed under nitrogen bubbling for 20 minutes.

To the S1c solution, expressed with respect to the total amount of monomers involved, 1.2×10⁻¹ mole % of sodium hypophosphite, 2.4×10⁻⁴ mole % of diethylene triamine penta acetic acid (DTPA) are then added, then the reaction is initiated by successive additions of 1.3×10⁻³ mole % of sodium persulfate and then 5.2×10⁻⁴ mole % of Mohr salt. The reaction time is 60 minutes, for a final temperature of 76° C. The resulting P1c polymer is in the form of a gel with an F factor=1.8. It is possible to granulate and then dry it in a stream of air at 70° C. for 60 minutes. The dry grains of the P1c polymer are then ground to obtain a particle size of less than 1.7 mm. The P1c polymer obtained is 100% water-soluble and has a molar mass of 964,000 Da.

### Example 4 (Counter Example): Gel Synthesis of an Acrylamide/Sodium Acrylate P1d Copolymer Under the Same Conditions as Described in Example 3, Except for the Addition of the P2b Polymer

In this example, the P1d polymer is synthesized as described in Example 3, replacing the 361 g of the 5.5% solution of the P2b polymer with 20 g of urea and 341 g of deionized water. The amount of dry matter in the aqueous solution to be polymerized is therefore identical to that of Example 3, namely 39.6% by weight.

The polymerization conditions and catalyst system are identical to those described in Example 3.

The reaction time is 60 minutes, for a final temperature of 80° C. The resulting P1d polymer gel has an F-factor=4.3. The gel is soft and does not support itself. Oven drying is required to obtain the 100% water-soluble polymer P1d with a molar mass of 994,000 Da.

Here again we see a strong difference in gel structure between the two polymers (P1c and P1d) that are close in molar mass and are derived from two polymeric charges with the same amount of dry matter.

### Example 5: Gel Synthesis of a P1e Acrylamide/Sodium Acrylate Copolymer, by Adding 5% by Weight of the P2e Polymer Containing 15% by Weight of Hydrophobic Monomer to the Polymerization Charge

In a first step, the P2e polymer of composition by weight: 15% N-tert-butyl acrylamide, 39% diethyl acrylamide, 8% sodium 2-acrylamido-2-methyl propane sulfonate, 38% acrylamide is synthesized in aqueous solution (13.8% by weight) by free radical polymerization.

In a second step, the P1e polymer is synthesized by gel radical polymerization from an aqueous solution comprising 5% by weight of the P2e polymer according to the following protocol: 50 g of the P2e polymer (360 g of the aqueous solution at 13.8% by weight of P2e), 79 g of acrylic acid, 403 g of acrylamide at 50% by weight in water and 70 g of sodium chloride are introduced into a 1.5 L beaker. Neutralization of the aqueous solution is performed using 87 g of sodium hydroxide at 50% by weight in water to reach a pH in the S1e solution of between 6.5-7.5. The dry matter of the aqueous S1e solution is 44.4% by weight. This aqueous S1e solution is cooled to 0° C. before being placed in a Dewar. 1.5 g of azobisisobutyronitrile are introduced into the S1e solution which is then homogenized using a hand blender at a speed of 500 rpm for 20 seconds before being degassed under nitrogen bubbling for 20 minutes.

To the S1e solution, expressed with respect to the total amount of monomers involved, 1.2×10⁻¹ mole % of sodium hypophosphite, 2.4×10 mole % of diethylene triamine penta acetic acid (DTPA) are then added, then the reaction is initiated by successive additions of 1.3×10⁻³ mole % of sodium persulfate and then 5.2×10⁻⁴ mole % of Mohr salt. The reaction time is 60 minutes, for a final temperature of 94° C. The resulting P1e polymer is in the form of a gel with an F factor=1.4. It is possible to granulate and then dry it in a stream of air at 70° C. for 60 minutes. The dry grains of the P1e polymer are then ground to obtain a particle size of less than 1.7 mm. The P1e polymer obtained is 100% water-soluble and has a molar mass of 935,000 Da.

### Example 6 (Counter Example): Gel Synthesis of an Acrylamide/Sodium Acrylate P1f Copolymer Under the Same Conditions as Described in Example 5, Except for the Addition of the P2e Polymer

In this example, the P1f polymer is synthesized as described in Example 5, replacing the 360 g of the 13.8% solution of the P2e polymer with 50 g of urea and 310 g of deionized water. The amount of dry matter in the aqueous solution to be polymerized is therefore identical to that of Example 5, namely 44.4% by weight.

The polymerization conditions and catalyst system are identical to those described in Example 5.

The reaction time is 80 minutes, for a final temperature of 90° C. The resulting P1f polymer gel has an F factor=4.7. The gel does not support itself. Oven drying affords a 100% water-soluble polymer P1f with a molar mass of 985,000 Da.

We observe a strong difference in gel structure between the two polymers (P1e and P1f) even though they are close in molar mass and are derived from two polymeric charges with the same amount of dry matter.

1. A water-soluble P1 polymer of weight-average molecular weight less than 2 million Daltons in powder form prepared by a gel polymerization process comprising the following sequential steps of:
a) forming an S1 solution by adding, and mixing, in a polymerization reactor:
between 20 and 60% by weight of hydrophilic monomers,
between 30 and 79% by weight of water,
between 1 and 10% by weight of a P2 polymer containing at least 1% by weight of hydrophobic monomers,
b) adding a pH regulator to the S1 solution,
c) degassing the S1 solution,
d) adding at least one polymerization initiator to the S1 solution, the S1 solution being at a temperature between −5° C. and 30° C.,
e) forming a P1 polymer gel by polymerizing the S1 solution from step d) and allowing the P1 polymer gel to age at a final polymerization temperature between 80° C. and 150° C. for at least 60 minutes without heating,
f) pouring the resulting P1 polymer gel into a granulator,
g) drying the P1 polymer gel,
h) grinding and sieving the P1 polymer into a powder.

2. The water-soluble P1 polymer of claim 1, wherein the P1 polymer has a weight-average molecular weight between 500,000 Daltons and less than 2 million Daltons.

3. A water-soluble P1 polymer according to claim 1, wherein the S1 solution of step a) contains between 1 and 8% by weight of the P2 polymer.

4. A water-soluble P1 polymer according to claim 1, wherein the S1 solution of step a) contains between 1 and 6% by weight of the P2 polymer.

5. A water-soluble P1 polymer according to claim 1, wherein the P2 polymer contains between 2% and 100% by weight of hydrophobic monomers.

6. A water-soluble P1 polymer prepared according to claim 1, wherein the P2 polymer contains between 5% and 100% by weight of hydrophobic monomers.

7. A water-soluble P1 polymer according to claim 1, wherein the P2 polymer contains between 10% and 100% by weight of hydrophobic monomers.

8. A water-soluble P1 polymer prepared according to claim 1, wherein the hydrophobic monomers of the P2 polymer are selected from: (meth)acrylic acid esters with an alkyl, arylalkyl and/or ethoxylated and/or propoxylated chain; (meth)acrylamide derivatives having an alkyl, arylalkyl or dialkyl and/or ethoxylated and/or propoxylated chain; cationic allyl derivatives having an alkyl, arylalkyl or dialkyl chain and/or an ethoxylated and/or propoxylated chain; hydrophobic anionic or cationic (meth)acryloyl derivatives; and anionic or cationic monomer derivatives of (meth)acrylamide carrying a hydrophobic chain.

9. A water-soluble P1 polymer according to claim 1, wherein the hydrophobic monomers of the P2 polymer are selected from:
n-hexyl (meth)acrylate, n-octyl (meth)acrylate, octyl (meth)acrylamide, N-tert-butyl (meth)acrylamide, lauryl (meth)acrylate, myristyl (meth)acrylate, myristyl (meth)acrylamide, pentadecyl (meth)acrylate, pentadecyl (meth)acrylamide, cetyl (meth)acrylate, cetyl (meth)acrylamide, oleyl (meth)acrylate, oleyl (meth)acrylamide, erucyl (meth)acrylate, erucyl (meth)acrylamide, and combinations thereof;
hydrophobic monomers of the general formula
CH₂═CR¹—COO—(EO)ₙ—(PO)ₘ—R²
wherein R¹ represents hydrogen or methyl, n is an integer of at least two, m is an integer from zero to 50, EO is an ethylene oxide group (—CH₂—CH₂—O—), PO is a propylene oxide group (—CH₂—CH(CH₃)—O—) and R² is a C₈-C₃₀ alkyl group or a C₈-C₃₀ arylalkyl group.

10. A water-soluble P1 polymer according to claim 1, wherein the hydrophobic monomers of the P2 polymer are selected from: halogenoalkylated derivatives of methacrylamidodimethyl aminopropyl with a C₈-C₁₆ alkyl chain, ethoxylated behenyl methacrylate, and N-tert-butyl acrylamide.

11. A water-soluble P1 polymer according to claim 1, wherein the P2 polymer is a terpolymer of diethyl acrylamide, N-tert-butyl acrylamide and sodium 2-acrylamido-2-methylpropanesulfonate.

12. A water-soluble P1 polymer according to claim 1, wherein prior to step a), the P2 polymer is functionalized at the end of the polymer chain with a hydroxyl, cyano, amine, phosphate, phosphonate, sulfate, sulfonate, xanthate, trithiocarbonate, dithiocarbamate, or dithioester fragment.

13. A water-soluble P1 polymer according to claim 1, wherein the P2 polymer is free of any carbon-carbon double bond.

14. A water-soluble P1 polymer according to claim 1, wherein the S1 solution comprises, by weight:
between 20 and 50% of hydrophilic monomers,
between 1 and 8% of polymer P2,
sufficient quantity of water for 100%.

15. A water-soluble P1 polymer according to claim 1, wherein the S1 solution comprises, by weight:
between 30 and 50% of hydrophilic monomers,
between 1 and 6% of polymer P2,
sufficient quantity of water for 100%.

16. A water-soluble P1 polymer according to claim 9, wherein the hydrophobic monomers of the P2 polymer are selected from:
hydrophobic monomers of the general formula
CH₂═CR¹—COO—(EO)ₙ—(PO)ₘ—R²
wherein n is an integer from 10 to 100, m is an integer from zero to 20, and n+m is from 10 to 40.

17. A water-soluble P1 polymer according to claim 2, wherein: the P2 polymer contains between 10% and 100% by weight of hydrophobic monomers.

18. A water-soluble P1 polymer according to claim 17, wherein the hydrophobic monomers of the P2 polymer are selected from:
(meth)acrylic acid esters with an alkyl, arylalkyl and/or ethoxylated and/or propoxylated chain; (meth)acrylamide derivatives having an alkyl, arylalkyl or dialkyl and/or ethoxylated and/or propoxylated chain; cationic allyl derivatives having an alkyl, arylalkyl or dialkyl chain and/or an ethoxylated and/or propoxylated chain; hydrophobic anionic or cationic (meth)acryloyl derivatives; and anionic or cationic monomer derivatives of (meth)acrylamide carrying a hydrophobic chain; or
n-hexyl (meth)acrylate, n-octyl (meth)acrylate, octyl (meth)acrylamide, N-tert-butyl (meth)acrylamide, lauryl (meth)acrylate, myristyl (meth)acrylate, myristyl (meth)acrylamide, pentadecyl (meth)acrylate, pentadecyl (meth)acrylamide, cetyl (meth)acrylate, cetyl (meth)acrylamide, oleyl (meth)acrylate, oleyl (meth)acrylamide, erucyl (meth)acrylate, erucyl (meth)acrylamide, and combinations thereof; or
hydrophobic monomers of the general formula
CH₂═CR¹—COO—(EO)ₙ—(PO)ₘ—R²
wherein R¹ represents hydrogen or methyl, n is an integer of at least two, m is an integer from zero to 50, EO is an ethylene oxide group (—CH₂—CH₂—O—), PO is a propylene oxide group (—CH₂—CH(CH₃)—O—) and R² is a C₈-C₃₀ alkyl group or a C₈-C₃₀ arylalkyl group; or
halogenoalkylated derivatives of methacrylamidodimethyl aminopropyl with a C₈-C₁₆ alkyl chain, ethoxylated behenyl methacrylate, and N-tert-butyl acrylamide;
or the P2 polymer is a terpolymer of diethyl acrylamide, N-tert-butyl acrylamide and sodium 2-acrylamido-2-methylpropanesulfonate.

19. A water-soluble P1 polymer according to claim 18, wherein the S1 solution comprises, by weight:
between 20 and 50% of hydrophilic monomers,
between 1 and 8% of polymer P2,
sufficient quantity of water for 100%.

20. A water-soluble P1 polymer according to claim 19, wherein the S1 solution comprises, by weight:
between 30 and 50% of hydrophilic monomers,
between 1 and 6% of polymer P2,
sufficient quantity of water for 100%.
